(19) United States
(12) Patent Application Publication
(10) Pub. No.: US 2016/0075172 A1
(43) Pub. Date: Mar. 17, 2016

(54) CYLINDRICAL PLASTIC BEADS FOR HEADPHONE WIRE

(71) Applicant: Thomas STORESUND, Los Angeles, CA (US)

(72) Inventor: Thomas STORESUND, Los Angeles, CA (US)

(21) Appl. No.: 14/950,691

(22) Filed: Nov. 24, 2015

(51) Int. Cl. B44C 1/18; H04R 1/10

(52) U.S. Cl. CPC B44C 1/18; H04R 1/1033

(57) ABSTRACT

A cylindrical plastic bead is modified by cutting a permanent incision lengthwise through the plastic. It is then easy to slip the bead on and off a headphone wire. The beads are pre-cut, packaged, and sold in bags by the hundreds. With one bag, the owner of a headset can easily decorate her headphone wires in an endless variety of patterns.

### 1. FIELD OF THE INVENTION

This invention is in the field of artistic adornments, particularly beads.

### 2. BACKGROUND AND OBJECTS OF THE INVENTION

Cylindrical plastic beads date to the 1950s. Each bead is a hollow cylinder. Traditionally, cylindrical beads are positioned on a pegboard. Each peg (about the size of a grain of rice) fits snugly inside the hollow interior of one bead. The pegs are closely packed together so that each bead makes contact with four neighboring beads. The beads come in several bold colors, and they can be assembled into creative artistic designs on the pegboard.

Polyethylene beads also have the special property of being fusible together with moderate heat. Traditionally, a flat iron and special paper is used to melt the beads together. They can then be removed from the pegboard and retain their design.

In the 21^{st} century, some hobbyists have become interested in using cylindrical plastic beads to adorn headphone wires. It is not possible to string beads onto a headphone wire directly. The wire has a jack on one end and ear buds on the other. These protrusions are too large to fit through the small holes in beads.

One solution is to cut a slice lengthwise down the side of a bead. Then the bead can be momentarily held open and slipped onto a wire. When the bead is let go, its elastic nature causes it to close tightly. If it was cut with a razor blade, it heals so securely that it is difficult to find the seam. Cutting and positioning many beads this way creates a uniquely adorned headphone wire.

The method explained above has been documented by a few bloggers. However, it is impractical for most people. There are at least three identifiable problems that this invention will solve.

The first main challenge is cutting the beads. One blogger described the difficulty of holding a bead down while cutting it. The beads had a tendency to pop up into the air instead of being cut. The consensus is that razor blades work best. But cylindrical beads are often used by children under ten, whose parents hopefully don't allow them to play with razors!

The second problem is time commitment. It takes hundreds of beads to properly adorn a headphone wire of typical length. It is difficult to hold, pin down, and cut even one bead, let alone hundreds of them. The project can take hours.

Third, as mentioned above, a plastic bead cut by a razor blade will heal so tightly that it is difficult to find the seam or hold it open. This presents a challenge in getting the beads on and off the wire. It takes quite a bit of time, force, and finesse to finagle each bead onto the wire. Once the beads are in place, it is equally difficult to locate a seam, pry a bead open, and remove it. Thus, someone using this homemade craft style will be essentially limited to one design for the long-term.

My invention provides packages of prefabricated cylindrical plastic beads with carefully measured lengthwise incisions. These packages improve on the craft style described above by making it much safer, faster, and easier to adorn headphone wires with beads and to vary the designs at will.

### 3. DESCRIPTION OF RELATED TECHNOLOGY

Plastic toy beads, made by chopping plastic tubes into short pieces, were introduced in 1958 by Munkplast AB in Sweden, under the brand name Nabbi. They were originally sewn together to form ribbons. Swedish patent 217,875 by Knutsson and Vallingby (1967) introduced the polyethylene bead with pegboard. These have been sold ever since under the brand name Perler. Perler beads are fusible with a flat iron. They are the most enduringly popular brand of plastic cylindrical beads, sold worldwide today with or without pegboards.

Today's plastic beads come in a variety of colors and other visible features. Some are transparent or semi-transparent with glitter suspended inside the plastic. Some glow in the dark. They are very visually appealing for children and adolescents.

The cylindrical beads are currently made in three standard sizes, with outer diameters of 2.5 mm, 5 mm, or 10 mm.

### 4. SUMMARY OF THE INVENTION

This invention provides bags of pre-cut plastic cylindrical beads. The beads are sized to fit around headphone wires. They come in a variety of colors and other visual features as described above. The incisions are precisely sized so that the beads may be easily placed onto and taken off of a headphone wire without falling off during use.

### 5. BRIEF DESCRIPTION OF THE DRAWINGS

FIG. 1 is a perspective view of a pre-cut cylindrical plastic bead.

FIG. 2 is a front plan view of the bead, looking through the incision into the interior of the bead.

FIG. 3 is a right plan view of the bead, wherein the incision is not visible.

FIG. 4 is a left plan view of the bead, the mirror image of FIG. 3.

FIG. 5 is a top-plan or bottom-plan view of the bead. It shows how a two-dimensional cross-section of the plastic forms a “C” shape after the incision is made.

FIG. 6 shows the positioning of a pre-cut bead onto a headphone wire.

FIG. 7 shows a headphone wire adorned with a plurality of the beads.

### 6. DETAILED DESCRIPTION OF THE PREFERRED EMBODIMENTS

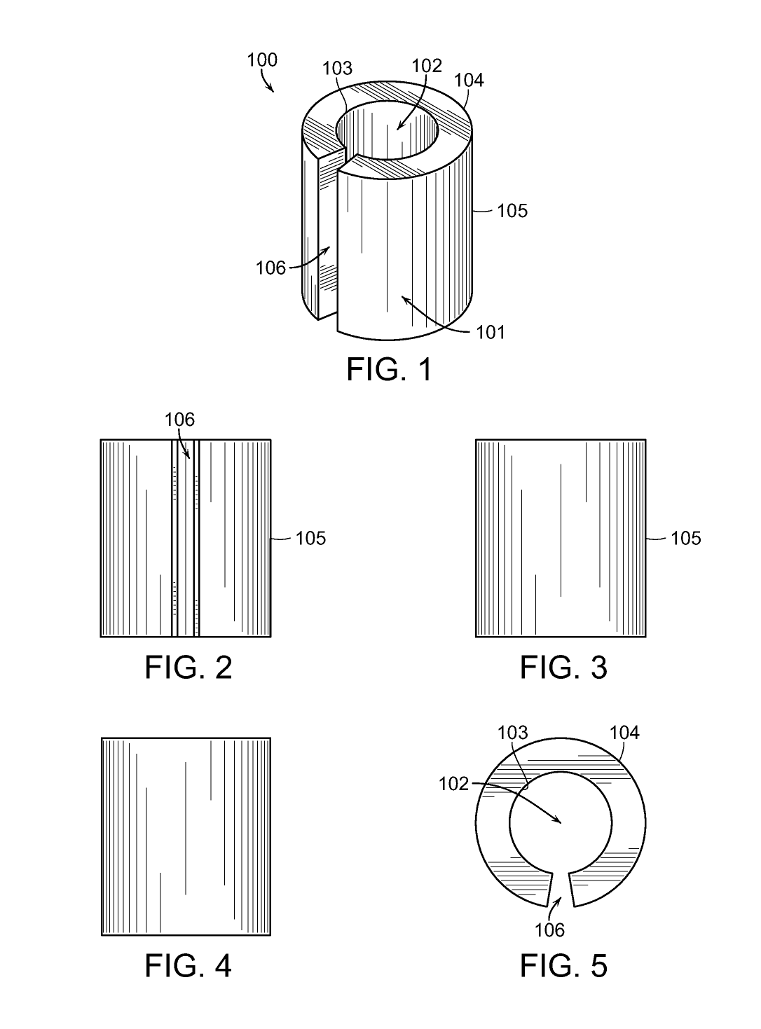

In FIG. 1, I identify the various parts of the bead (100). The bead is in the shape of a hollow cylinder. The solid part of the bead is made of plastic (101). It has a hollow interior (102). The two-dimensional cross-section of the hollow cylinder includes an inner circle (103) and an outer circle (104) at each base of the cylinder. The length (105) is the perpendicular distance from one base of the cylinder to the other. During fabrication, an incision (106) is made lengthwise through the plastic, from the outer circle to the inner circle.

For the purposes of this invention, the ideal length (105) is in the range of four to ten millimeters. The ideal diameter of the inner circle (103) is in the range of two to three millimeters. The ideal diameter of the outer circle (104) is in the range of four to six millimeters. The ideal width of the incision (106) is in the range of 0.2 to 0.5 mm.

It will be noted that the incision remains open. This contrasts with the homemade method of cutting beads with a razor blade. Razor-made incisions elastically “heal” when the bead is let go. Then it becomes difficult to locate the seam, let alone pry it open. In this invention, the incision is easy to find.

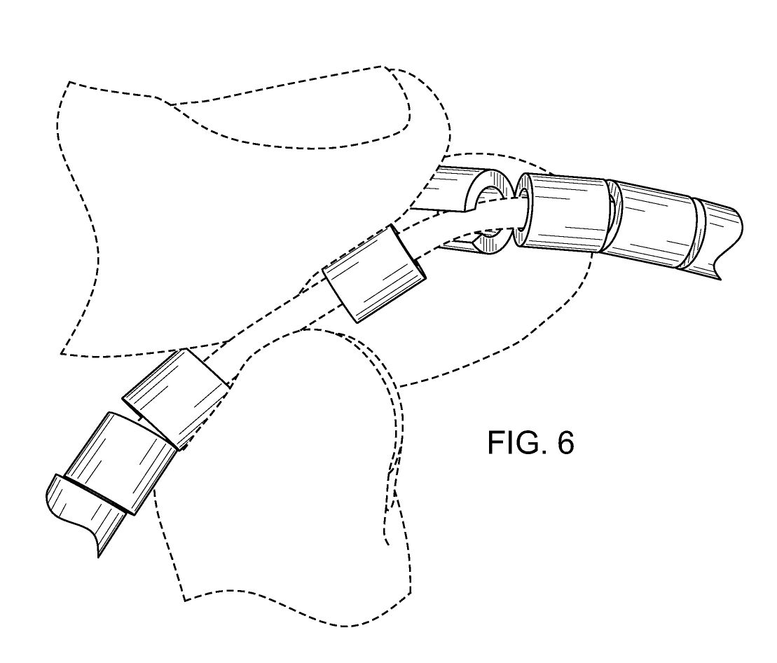

In FIG. 6, we see a bead (100) being positioned onto a headphone wire (601). The incision (106) must only be pried open a slight amount to position it onto the headphone wire or to remove it. When the bead is let go, the incision is slightly narrower than the headphone wire. Thus, the bead stays on the wire.

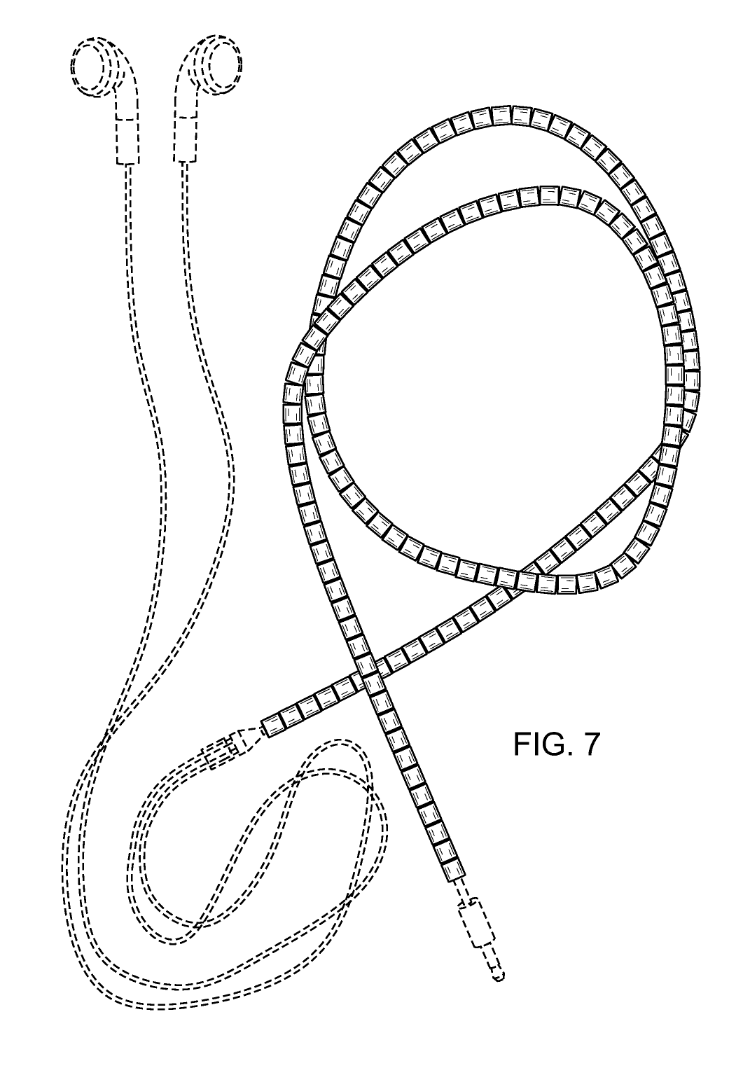

The pre-cut bead (100) will be sold in packages of about 250-1,000 beads. Each package will allow a user to fully adorn a headphone wire. FIG. 7 shows a plurality of beads adorning a headphone wire. In practice, a typical headphone wire will easily accommodate 100-500 beads. FIG. 7 shows the plug-in jack (701) and the ear buds (702). These components are too large to pass through the hollow interior (102) of the beads, thus necessitating the incision (106) and this side-wise threading of the headphone wire. The wire could be adorned all the way to the earbuds.

The beads will be packaged and sold in a variety of colors and visual schemes. The owner of the headphones may be interested in changing the decorative pattern from one day to another. A bead can be removed very quickly and easily by simply prying the incision slightly open again as in FIG. 6. Again, this contrasts with the homemade razor-cut beads, where the incisions heal very tightly and become difficult to locate later.

I claim:

1. A bead for adorning a headphone wire, comprising
a cylindrical plastic bead with a hollow interior;
a lengthwise incision cut fully through the plastic of the bead so that the two-dimensional cross-section of the bead assumes a “C” shape.

2. The bead of claim 1, wherein
the length of the bead, as measured from base to base, ranges from 4 to 10 mm;
the diameter of the bead's inner circle ranges from 2 to 3 mm;
the diameter of the bead's outer circle ranges from 4 to 6 mm;
the width of the incision ranges from 0.2 to 0.5 mm.

3. A package comprising a plurality of beads as described in claim 2, wherein
the number of beads in the package ranges from 250 to 1,000;
the beads in the package vary in color and visual pattern.

4. A method of commerce in beads for adorning headphone wires, comprising
making or buying a mass quantity of cylindrical plastic beads;
cutting a lengthwise incision fully through the plastic of each bead;
packaging the beads together in bags;
selling the bags as units.

5. The method of commerce as in claim 4, wherein
the length of each bead is between 4 and 10 mm;
the diameter of the inner circle of each bead is between 2 and 3 mm;
the diameter of the outer circle of each bead is between 4 and 6 mm;
the width of the incision in each bead is between 0.2 and 0.5 mm;
the number of beads in each bag is between 250 and 1,000.
